(19) United States
(12) Patent Application Publication
(10) Pub. No.: US 2015/0039825 A1
(43) Pub. Date: Feb. 5, 2015

(54) Federated Tiering Management

(71) Applicant: Seagate Technology LLC, Cupertino, CA (US)

(72) Inventor: David Bruce Anderson, Minneotnka, MN (US)

(73) Assignee: Seagate Technology LLC, Cupertino, CA (US)

(21) Appl. No.: 13/958,077

(22) Filed: Aug. 2, 2013

(51) Int. Cl. G06F 3/06

(52) U.S. Cl. CPC G06F 3/0685; G06F 3/0619; G06F 3/0646
USPC 711/114

(57) ABSTRACT

Apparatus and methods are described for dynamically moving data between tiers of mass storage devices responsive to at least some of the mass storage devices providing information identifying which data are candidates to be moved between the tiers.

### SUMMARY

Apparatus and methods are described for dynamically moving data between tiers of mass storage devices responsive to at least some of the mass storage devices providing information identifying which data are candidates to be moved between the tiers.

### BRIEF DESCRIPTION OF THE DRAWINGS

FIG. 1 shows a first storage subsystem in a first state;

FIG. 2 shows the first storage subsystem in a second state;

FIG. 3 shows a second storage subsystem in a first state;

FIG. 4 shows the second storage subsystem in a second state;

FIG. 5 shows a process used by the second storage subsystem;

FIG. 6 shows another process used by the second storage subsystem;

FIG. 7 shows a mass storage device used by the second storage subsystem;

FIG. 8 shows a further process used by the second storage subsystem;

FIG. 9 shows a third storage subsystem; and

FIG. 10 shows another mass storage device.

### DETAILED DESCRIPTION

Mass storage devices, such as hard disc drives (HDDs), solid-state drives (SSDs) and hybrid disc drives (Hybrids), can be aggregated together in a storage subsystem. The storage subsystem includes a controller to control the access to the mass storage devices. Storage subsystems can be used to provide better data access performance, data protection or maintain data availability.

Tiering has become an essential element in the optimization of subsystems containing multiple types of mass storage devices. In such a storage subsystem the mass storage devices are grouped together by type, e.g. having similar performance characteristics, to form a tier. One example of tiering maintains the most accessed data on the highest performance tier to give the storage subsystem increased performance. Lesser accessed data is saved on a lower performance tier to free space on the higher performing tier.

However, the dynamic nature of data access patterns and the lack of timely user-digestible information from which to deduce effective storage management makes maintaining that data in the highest performance tier difficult. To overcome that the tiering can be done automatically to keep performance in line with changing operational conditions. Yet maintaining a constant assessment of the data access patterns of all the mass storage devices in a storage subsystem can be a considerable burden on the controller, and can be inefficient use of storage.

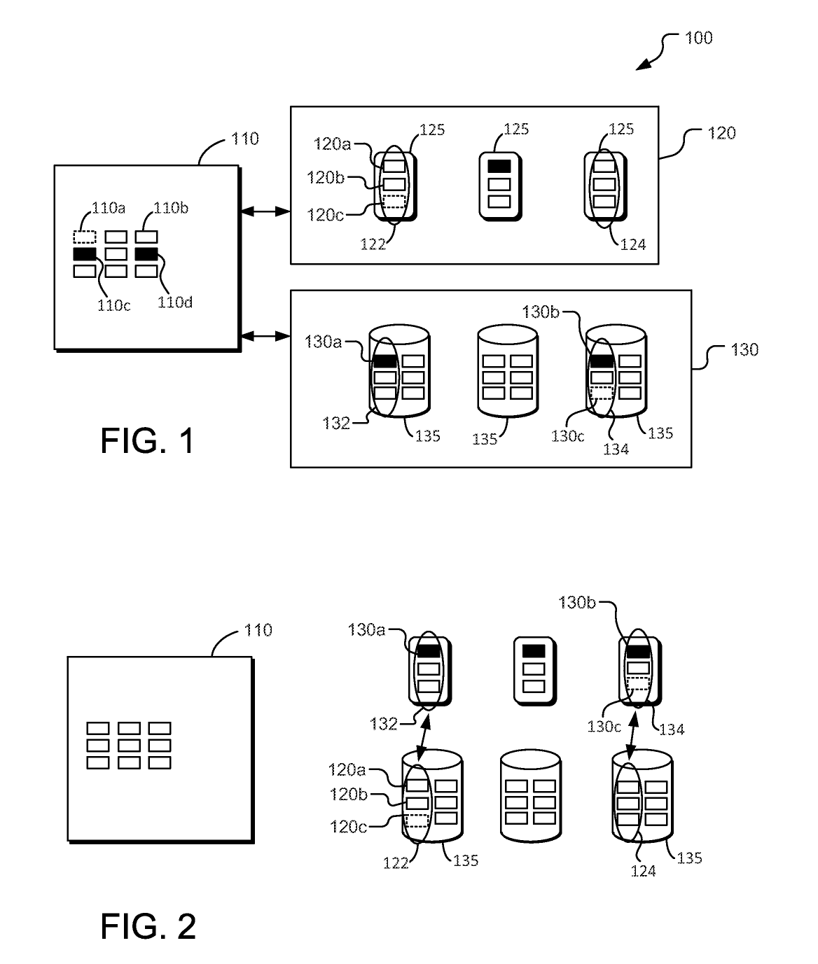

To illustrate, refer to storage subsystem 100 of FIG. 1. Subsystem 100 includes a controller 110, a first storage tier 120 and a second storage tier 130. First and second storage tiers 120, 130 can be respective SSDs 125 and HDDs 135. As such, first storage tier 120 will have a faster random access read time than second storage tier 130. To utilize that faster time, controller 110 moves data between the tiers based on access patterns.

The data in storage subsystem 100 is exemplified by a device data segment 120a. As shown, there are three device data segments, e.g. 120a, 120b, 120c, in each SSD 125. Device data segment 120c is the least busy device data segment in first storage tier 120. There are six device data segments in each HDD 135. Device data segments 130a and 130b are the busiest in the second storage tier 130. Device data segment 130c is the least busy.

Controller 110 is tasked with managing the movement of data among the tiers to optimize performance. To that end controller 110 uses subsystem data chunks to keep track of data accesses. To lower the overhead of this tracking, subsystem data chunks are sized larger than device data segments. In this particular example, subsystem data chunk 110a corresponds to the device data segment group 122 that includes device data segments 120a, 120b, 120c. Thus subsystem data chunk 110a is the size of three device data segments. Subsystem data chunk 110b corresponds to device data segment group 124. Subsystem data chunk 110c corresponds to device data segment group 132 that includes device data segment 130a. Subsystem data chunk 110d corresponds to device data segment group 134 that includes device data segments 130b, 130c. Anytime a device data segment is accessed, controller 110 counts that access for its corresponding subsystem data chunk. In this example, accesses to any of the device data segments in group 122 count as an access for subsystem data chunk 110a.

As previously explained, device data segment 120c is the least busy device data segment of first storage tier 120. Then as controller 110 tracks data accesses, it determines that respective corresponding subsystem data chunk 110a is the least busy subsystem data chunk for first storage tier 120. Likewise, with device data segments 130a and 130b being the busiest device data segments in second storage tier 130, controller 110 determines that respective corresponding subsystem data chunks 110c and 110dc are the busiest subsystem data chunks for second storage tier 130. Therefore, controller determines to move the least busy and busiest subsystem data chunks to the other tier.

Movement of the subsystem data chunks between the storage tiers will be explained by referring to FIG. 2. There, device data segment group 122 (including device data segments 120a, 120b, 120c) corresponding to subsystem data chunk 110a are written to HDD 135 that previously maintained the device data segment group 132 (including device data segment 130a) that corresponds to subsystem data chunk 110c. Similarly, device data segment group 124 that corresponds to subsystem data chunk 110b is written to HDD 135 that previously maintained the device data segment group 134 (including device data segments 130b, 130c) that correspond to subsystem data chunk 110d. Subsystem data chunks 110c and 110d are written to the locations that previously stored device data segment groups 122 and 124, respectively.

Here is where an inefficiency in this tiering management scheme is exposed. Note that along with the transfer of the device data segment group 134 is device data segment 130c. That segment was the least busy device data segment in second storage tier 130. Now that device data segment is in first storage tier 120 using valuable storage space that could be used for device data segments that are busier. This happened because of a tradeoff made by this tiering management scheme. Consider that tracking all data access activity for each device data segment at the system level has negative implications to subsystem controller processing overhead and memory requirements. Additionally, as the underlying tier storage capacity grows, the subsystem memory dedicated to tracking the access activity grows or the tracking precision of the subsystem data chunk size is compromised. As a result, the subsystem memory and processing overhead often dictates that the subsystem controller use a bigger chunk—bigger than the device data segment—than would be optimal. This leads to diminished performance gains caused by such operations as moving a least busy device data segment to the highest performance tier.

To overcome the deficiencies of this kind of tiering management scheme, mass storage devices constituting the subsystem are used to contribute to the tiering management task to reduce implications to subsystem controller processing overhead and memory requirements while at the same time improving the overall effectiveness of the tiering. Spreading the task of monitoring mass storage device data segment activity levels and identifying candidate segments for movement across the mass storage devices—that is, by federating it—will have the mass storage devices assume a relatively modest additional responsibility individually but collectively significantly reduce the controller tasks.

With this the tiering also is made more effective. While the controller makes a compromise between the size of the subsystem data chunks and the amount of controller processing overhead and memory consumed for monitoring device data segment activity levels, federated tiering can work on very small capacity units because all the mass storage devices are doing the work in parallel.

One potential aspect of the mass storage device contributing to the tiering management is that much of the data it provides to the controller is data it may already maintain. Consider that even the smallest and simplest of mass storage devices has an internal cache. To manage this internal cache, the mass storage device keeps track of the access activity it services and makes the most often requested segments available in its cache. This will optimize the performance benefit of the cache. SSDs monitor access activities for data management techniques such as wear-leveling and garbage collection of the flash cells to ensure storage endurance.

These mass storage devices can then provide this access activity information to the controller. This enables the controller to have accurate, timely and comprehensive information indicating the high or low access activity segments. Using that information the controller can then optimize the subsystem performance. Thus, with very little measurement activity of its own, the subsystem controller will be in position to extract the best performance out of a given configuration. Since the mass storage devices may do much of this work already in connection with the oversight of their own internal caches or other internal management, the additional responsibility incurred by federated tiering management is relatively modest.

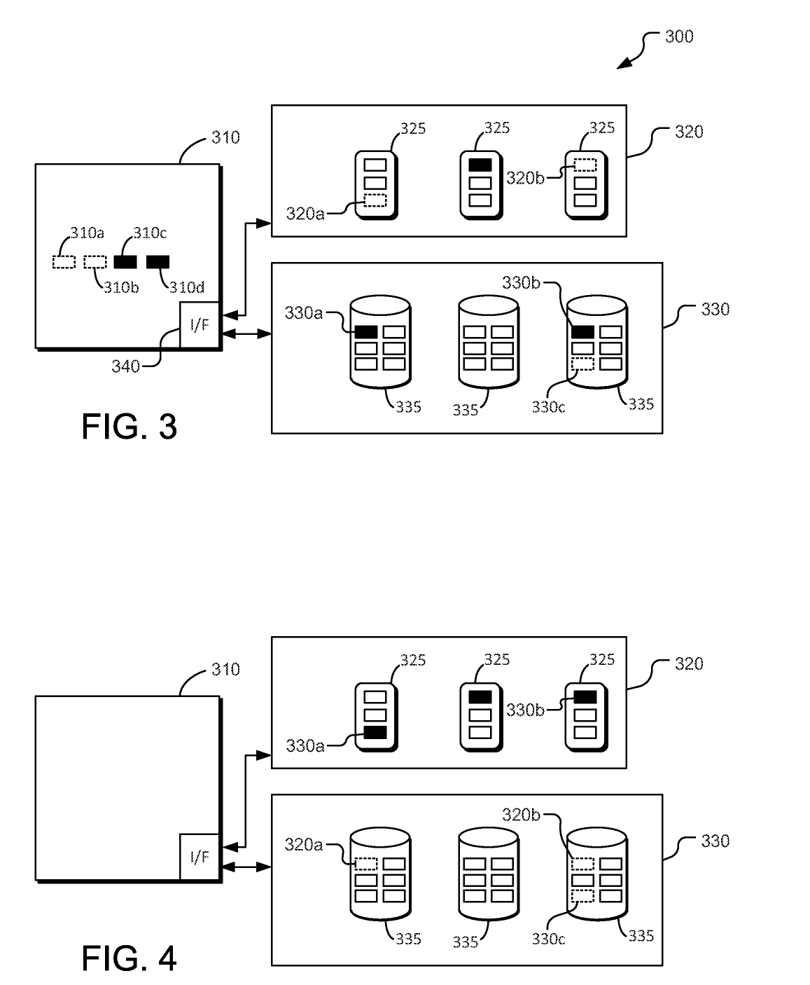

The controller will configure the mass storage devices in each tier as to which access activity information it will request from them, then request that information later. Each mass storage device preferably keeps track of the read and write activity on the busiest or least busy segments of its storage space, including noting sequential reads and writes. In order to determine which segment should be moved among the tiers, the controller may ask for a list of the busiest or least busy segments. To illustrate, reference is made to FIG. 3 and the shown subsystem 300. Here, controller 310 requests from the mass storage devices of the first storage tier 320 which device data segments are the least busy, potentially meeting a threshold value or other criterion. In response, controller 310 receives access activity information for device data segments 320a, 320b. Controller 310 requests from the mass storage devices of the second storage tier 330 which device data segments are the busiest. In response, controller 310 receives access activity information for device data segments 330a, 330b.

Controller 310 then determines if the four identified device data segments should be moved, based in part on whether the target tier can receive it and still accomplish the purpose of the move. As seen in FIG. 3, first and second storage tiers 320, 330 can accommodate the data movement since both reported two device data segments. In FIG. 4 controller 310 proceeds to move the identified device data segments between the storage tiers. The storage locations for device data segments 320a and 330a are swapped, and the storage locations for device data segments 320b and 330b are swapped. With this the access performance of device data segments 330a and 330b is increased. And, unlike the tiering management scheme of FIGS. 1 and 2, no unwarranted device data segment moves are performed. The result is a minimization of the amount of data that is not accessed that much from being put into a higher-performing tier. Note that least busy device data segment 330c was not moved to first storage tier 320. Also, controller 310 used less processing and memory resources to manage the four device data segments 320a, 320b, 330a and 330b than controller 110 used to manage the 15 subsystem data chunks shown in FIGS. 1 and 2.

The above description is but one of many examples. Further examples will be explained by referring to Table 1 below. Assume each mass storage device in the subsystem maintains the access activity information shown in Table 1. The first column shows the device data segments as LBA ranges. These LBA ranges can be defined in any way. One way is to use the mean transfer length for the accesses by the subsystem. Yet the segment size can be different for each tier, and each mass storage device, but that will lead to more overhead for the controller.

For each LBA range there are associated read and write (access) frequency values. These values can be determined by meeting a threshold access frequency. For example, the subsystem controller may program the mass storage devices to count as an access frequency some value, such as 150 IOs/sec. Or the mass storage devices can simply increment each read and write column as they occur, and the subsystem controller is left to determine the access frequency. This can be done by the subsystem controller determining the time between access activity information requests. Or the subsystem controller can time the access activity information requests at fixed intervals. Then the mass storage device would send only the access activity information that met a certain threshold value. Also, the information in addition to the read activity is provided in some cases because the best decision to move data between tiers may not be determined by considering read activity only.

Moreover, the mass storage devices can provide information that may not be practical for the controller to accumulate. For example, the access activity information in Table 1 also has a column that shows whether the accesses are sequential. The subsystem controller would have great difficulty accurately detecting sequential accesses. Yet sequential accesses can be important information in considering whether to demote or promote device data segments.

TABLE 1

| LBAs | | | Sequential |
|---|---|---|---|
| (Segment) | Read | Write | Access |
| 0-15 | 0 | 0 | N |
| 16-31 | 0 | 7 | N |
| 32-47 | 18 | 15 | Y |
| 48-63 | 18 | 0 | Y |
| 64-79 | 18 | 15 | N |
| 80-95 | 18 | 0 | N |

The use of the access activity information by the subsystem controller is determined by the programming of the subsystem. The subsystem can be programmed, for example, so that each mass storage device sends access activity information for device data segments that meet some threshold like access frequency only (e.g. 150 IOs/sec) or access frequency for the device data segments that fall with a certain percentage of the storage capacity of the mass storage device. For the latter, if the mass storage device is asked for the busiest (or least busy)1%, the mass storage device will report which segments in the user storage space, totaling 1% of the mass storage device capacity, are the busiest (or least busy) in terms of reads or writes, or both.

Assume the subsystem is programmed so that each mass storage device provides to the subsystem controller the access activity information for the device data segments that meet only an access frequency of <5 accesses/time unit for the highest performance tier (such as first storage tier 320 in FIGS. 3-4) and >10 accesses/time unit for a lower performance tier (such as first storage tier 330 in FIGS. 3-4). If a mass storage device in the highest performance tier maintained the access activity information in Table 1, the access activity information for LBAs 0-15 and 16-31 would be reported to the subsystem controller. If a mass storage device in the lower-performance tier maintained the access activity information in Table 1, the access activity information for LBAs 32-47, 48-63, 64-79 and 80-95 would be reported to the subsystem controller.

TABLE 2

| | Starting | Ending | Read | Write | | Seq. |
|---|---|---|---|---|---|---|
| Rank | LBA | LBA | Count | Count | Seq. Reads | Writes |
| 1 | | | | | | |
| 2 | | | | | | |
| . . . | | | | | | |
| n | | | | | | |

Table 2 is another example of a possible monitoring table. The subsystem controller would ask for the most active device data segments, perhaps the top 0.01% of the active chunks (chunk size specified in a mode page perhaps) or, as a possible alternative, the top N (such as 100) active chunks. Both starting and ending LBAs can advantageously specify when device data segments as chunks are contiguous as a single large chunk, instead of multiple smaller ones.

The threshold(s) used to promote or demote device data segments can be based on the storage capacity of a tier. In the case of first storage tier 320 in FIGS. 3 and 4, the more storage capacity added to it will allow lower thresholds to be used to promote device data segments. In general, the subsystem can be scaled with more tiers and more drives since each drive adds computational power.

While the mass storage devices report relevant access activity information, in one embodiment the controller decides what segments should move and where they should be moved to. The controller can compare the access activity information retrieved from all the mass storage devices and decide where there are segments that deserve promotion/demotion, which mass storage device in a tier those segments should be moved, and how to promote/demote (if possible) from that mass storage device sufficient segments to allow the promoted/demoted segments to be written. The controller will then initiate reads from the source mass storage device(s) and corresponding writes to the target mass storage device(s) it has chosen to complete both the demotion of least busy device data segment(s) and the promotion of the busiest busy device data segment(s). Device data segments are then read from a source mass storage device into a memory associated with the subsystem controller, then sent from that memory to the target mass storage device. Alternatively, the tiers or mass storage devices can communicate among themselves so that the subsystem controller does not have to be involved with the actual data movement. This can be accomplished with the appropriate communication protocol existing between the mass storage devices. After the data is moved the subsystem controller is notified by the associated mass storage devices or tiers that the data has been moved.

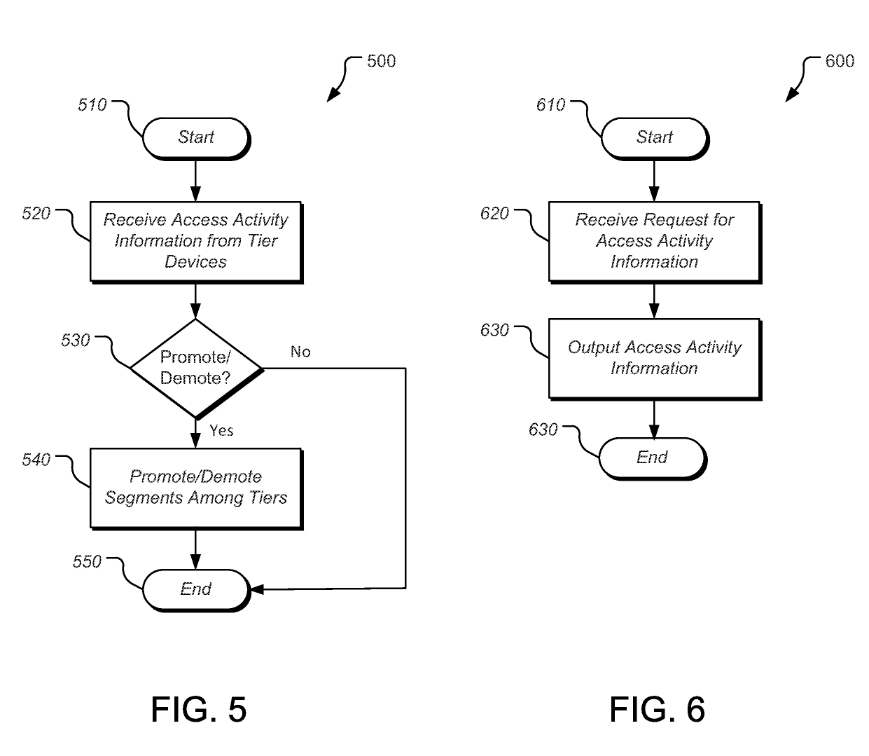

FIG. 5 shows one process for the subsystem controller described above. Process 500 starts at step 510, the proceeds to step 520 where the subsystem controller receives the access activity information. That information can be obtained from the mass storage devices upon a request from the subsystem controller. At step 530 the subsystem controller determines whether to promote or demote, or both, any device data segments that correspond to the received access activity information. If a determination is made to promote or demote, or both, any device data segments that correspond to the received access activity information, that is done at step 540. Process 500 then proceeds to end at step 550. If a determination is made not to promote or demote any device data segment, then process 500 proceeds to termination step 550.

FIG. 6 illustrates a process for a mass storage device described above. Process 600 starts at step 610, then proceeds to step 620 where the mass storage device receives a request for access activity information. At step 630 the mass storage device outputs the access activity information responsive to the request received at step 620. Step 630 ends process 600.

Additional programming (e.g. policies) of the subsystem, particularly the subsystem controller, may be used in addition to that described. Additional programming can be based on characteristics of the mass storage devices. To illustrate, SSDs do not perform well if the same device data segment is written a lot due to the time needed to write the data to the SSD and the wear characteristics of the SSD memory cells. In that case the subsystem can be programmed, preferably the subsystem controller, to move device data segments with high write accesses to a non-SSD mass storage device. As shown in FIGS. 3 and 4, that would mean moving the device data segment to an HDD in second storage tier 330. In this example, if LBAs 64-79 in Table 1 are stored in an SSD, they could be moved to an HDD since they have a high write access. This would allow segments with less reads and writes to be maintained in the SSDs. A high write access is relative to the type of memory used.

Additional programming can be based on sequential accesses of the device data segments. Specifically, even if the accesses are predominantly reads, if they are all or mostly sequential, the SSD may not perform sufficiently better to justify moving the data off HDDs. If, however, much of the read activity is sequential, it may not be wise to promote the segment. Sequential performance on an SSD is often not much greater than that of an HOD, and segments with more random activity, even if they have fewer overall reads, may be better candidates for promotion. The improvement will be greater as there is more access time removed from the storage system service times, while in the sequential access only a modest difference in transfer rate will be seen. In this example, if LBAs 48-63 in Table 1 are stored in an SSD, they could be moved to an HDD since they have a sequential access.

Further additional programming can be based on empirical data. Such is the case where empirical data shows that at certain times specific device data segments have their access activity changed so that they should be moved to another, appropriate tier. After that data is moved, it can be locked to maintain it in its tier regardless of the access activity information for that tier.

As described for the subsystem in FIGS. 3 and 4, the controller obtained the device segment information from each tier so that it can move the same number of device data segments from one tier to another. This may not always be done, however. When a tier is being populated, the controller does not need access activity information from that tier to move device data segments to it.

The controller can obtain periodically or event driven updated access activity information from the mass storage devices. The controller can interrogate or request the mass storage devices to get the latest access activity information and make promotion/demotion decisions responsive to changes in activity. This may take place under one or more conditions. The controller may prefer to get regular reports on the busiest or least busy data segments from any or all of the mass storage devices. Alternatively, the controller may find it more efficient to get access activity information only when some threshold has been exceeded, such as a 10% change in the population of the busiest or least busy segments. In this case, the mass storage device will maintain the access activity data and set a flag to indicate X% or more of the N busiest or least busy segments have changed. That is, the segments making up the X% busiest or least busy, have had at least X% of those as new entries.

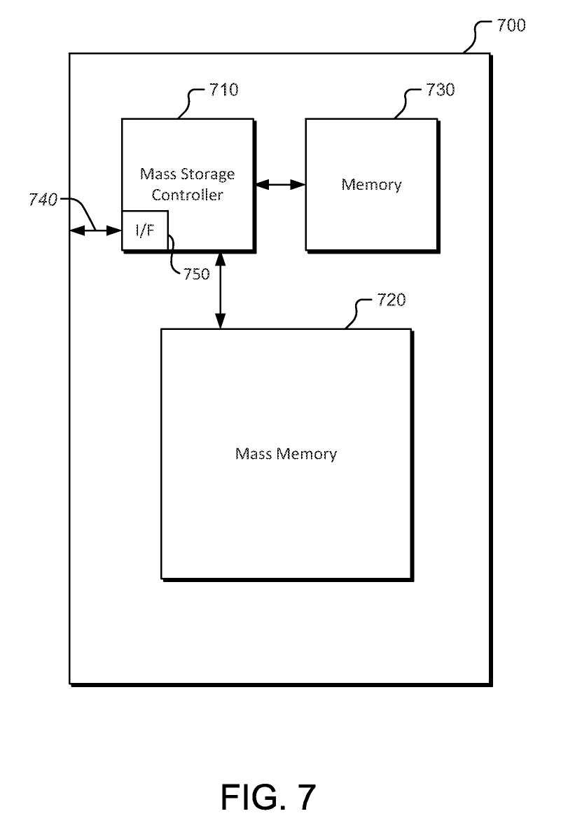

An example of a mass storage device is shown in FIG. 7. Mass storage device 700 includes a mass storage controller 710 coupled to mass memory 720 and memory 730. Mass memory can be one or more of magnetic, optical, solid-state and tape. Memory 720 can be solid state memory such as RAM to use for data and instructions for the controller, and as a buffer. Mass storage controller 710 can interface with the subsystem controller with interface I/F 750 via electrical connection 740.

The mass storage devices can be programmed on what to include in the access activity information. Such programming could be done by using the mode page command in the SCSI standard. The access activity information is then sent over the storage interface when requested by the subsystem controller.

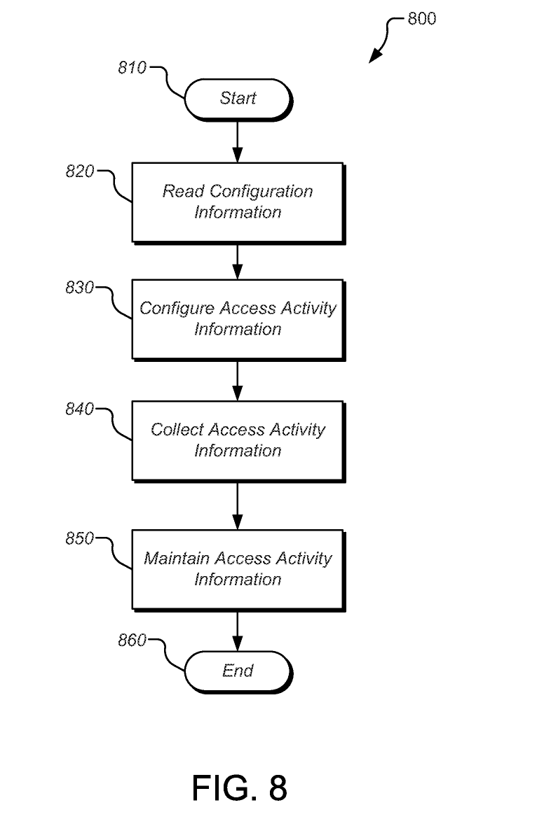

An example of that is shown in FIG. 8 by process 800. Beginning at step 810, process 800 proceeds to step 820 where firmware operating the mass storage controller causes configuration information to be read, possibly from mass memory 720. The configuration information can include the size of the device data segments in LBAs, and other information such as shown in Tables 1 and 2. At step 830 the access activity information is configured by creating a table in memory (e.g. memory 730). As the mass storage device operates, it collects access activity information at step 840. At step 850 the information is maintained in memory, such as memory 730. If memory 730 is volatile, the access activity information can be saved to memory 720. Process 800 ends at step 850.

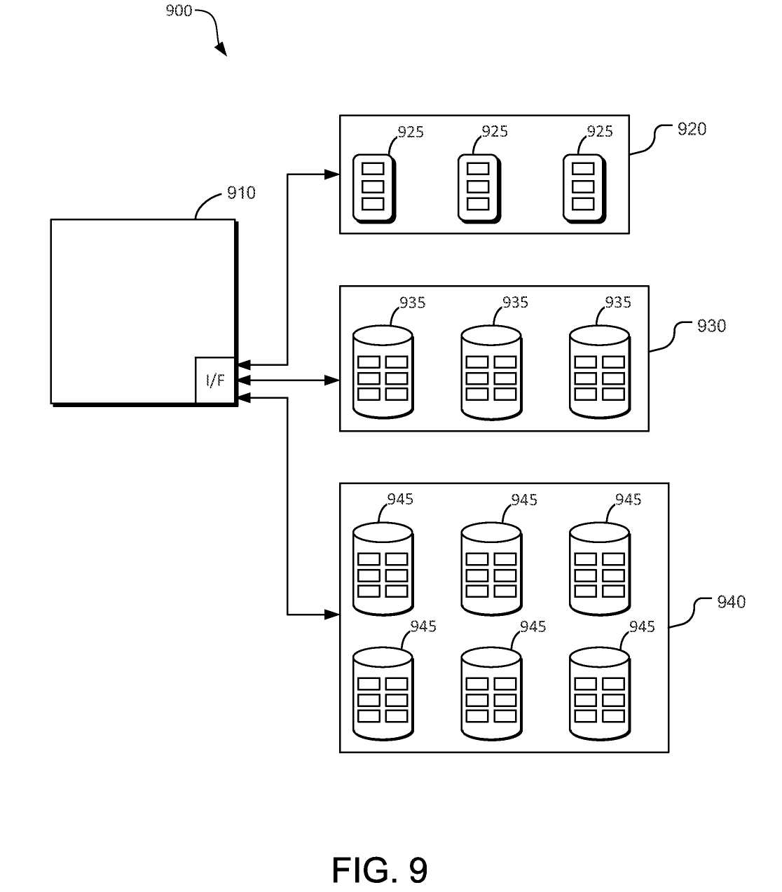

There can be any number of tiers greater than the two shown. One specific subsystem includes three tiers as shown in FIG. 9 Here system 900 includes a subsystem controller 910 couples to tiers 920, 930, 940. Tier 920 can include the highest performance mass storage devices 925, such as SSDs. Tier 930 can include the next highest performance mass storage devices 935 such as FC/SCSI, hybrid drives, short-stroked or high rpm disc drives. Tier 940 can include the lowest performance mass storage devices 945 such as SATA, tape or optical drives. Regardless of the number of tiers, not all the mass storage devices in a tier have to be the same. Instead, they can have at least one characteristic that falls within a certain range or meets a certain criterion. Furthermore, there can be a single mass storage device in at least one tier.

In operation, mass storage devices 935 can provide to subsystem controller 910 access activity information for its least busy and busiest device data segments. Subsystem controller, like described above, can move the least busy segments to tier 940 and move the busiest segments to tier 920. Tiers 920, 940 can provide their busiest and least busy data segments, respectively. Here subsystem controller 910 can determine which of the other two tiers the device data segments should be moved. Alternatively, these device data segments can be moved to tier 930 so they are compared to the other device data segments in tier 930. From there they can be moved to another tier if appropriate.

At least the embodiments described above for FIGS. 3-10 can be used in a distributed file system, such as Hadoop. The tiered storage can be used in a data node, where the subsystem controller of the data node determines what data to move among the tiers. The distributed file system on the data node may or may not be involved with the data movement among the tiers. If it is, then the distributed file system can by itself or in conjunction with the subsystem controller determine what data to move among the tiers. Policies in the controller or distributed file system may then include priorities to avoid conflicts between the two. The tiered storage can also be used as a portion of or an entire cluster. Each tier of the tiered storage can be a data node. Here the distributed file system would act as the subsystem controller to determine the data movement among the tiers.

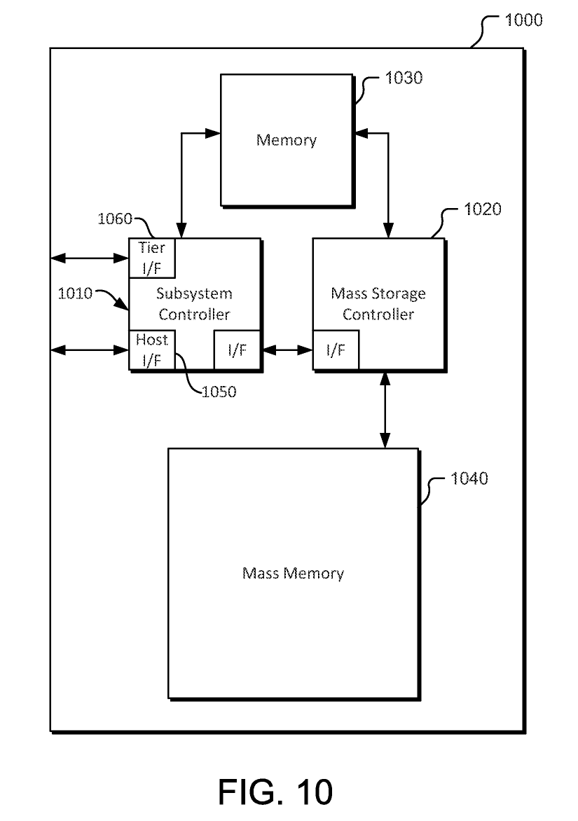

Also, at least one of the mass storage devices may include the functionality of the subsystem controller. This is shown in FIG. 10. A mass storage device 1000 includes a subsystem controller 1010, a mass storage controller 1020, a memory 1030 and a mass memory 1040. Controllers 1010, 1020 can be implemented as separate hardware with or without associated firmware or software, or as single hardware with or without associated firmware or software. With that functionality residing in the mass storage device, the other mass storage devices would communicate with that mass storage device through tier interface 1060. Host interface 1050 is used by the subsystem controller to receive commands from a host or other device requesting data access. The controllers communicate between themselves using the shown interfaces I/F. The mass storage devices can be manufactured with the subsystem functionality, and later enabled to control a subsystem. If the subsystem functionality is operable in more than one mass storage device, all the subsystem functionality can be divided among them.

The described apparatus and methods should not be limited to the particular examples described above. The controllers of FIGS. 3-10 can be hardware, whether application specific, dedicated or general purpose. Furthermore, the hardware can be used with software or firmware.

Various modifications, equivalent processes, as well as numerous structures to which the described apparatus and methods may be applicable will be readily apparent. For example, the controller may be a host CPU that can use directly attached drives. The mass storage devices can also be optical drives, solid state memory, direct attached or tape drives, or can be high- and low-performance HDDs. A tier can be a SAN, tape library or cloud storage. The storage interface physical connections and protocols between the subsystem controller interface 340 (FIG. 3) and mass storage devices or tiers can be ethernet, USB, ATA, SATA, PATA, SCSI, SAS, Fibre Channel, PCI, Lightning, wireless, optical, backplane, front-side bus, etc.

Not all the mass storage devices need to provide the access activity information for the subsystem controller to move data. Instead, some of the drives can provide the information to reduce the burden on the subsystem controller. One example is where a tier is made of solid state memory that is controlled by the subsystem controller. In that case the subsystem controller can be monitoring the access activity of the memory. Or the subsystem controller may move data to that memory regardless of the other data contained in it.

Movement of the device data segments can be based on the mass storage device capacity, price or other function instead of, or in addition to, performance. Movement can also be based on the value of the device data segment such as +mission or business critical data. Movement can be based on user- or application-defined criteria.

What is claimed is:

1. A method comprising dynamically moving data between tiers of mass storage devices responsive to at least some of the mass storage devices providing information identifying which data are candidates to be moved between the tiers.

2. The method of claim 1 wherein the dynamically moving data between tiers is performed by a subsystem controller.

3. The method of claim 1 wherein the mass storage devices each include a controller that is separate from the subsystem controller.

4. The method of claim 2 further comprising the subsystem controller requesting the mass storage devices to provide information identifying which data are candidates to be moved between the tiers.

5. The method of claim 4 further comprising the mass storage devices providing the information responsive to the request, the information including a device data segment and at least one of associated read accesses, write accesses, sequential reads and sequential writes.

6. The method of claim 4 further comprising the subsystem controller configuring the mass storage devices to provide the information.

7. The method of claim 1 further comprising the mass storage devices collecting the information for a use separate from moving the data between the tiers.

8. The method of claim 1 further comprising the mass storage devices moving the data among themselves and notifying the subsystem controller that the data has been moved.

9. The method of claim 1 wherein the tiers are part of a distributed file system.

10. A system comprising:
a subsystem controller; and
tiers of mass storage devices coupled to the subsystem controller, each configured to output to the subsystem controller access activity information that is used to move data among the tiers.

11. The system of claim 10 wherein the subsystem controller and tiers are coupled together by respective interfaces.

12. The system of claim 10 wherein the tiers are different in at least one of performance, cost and capacity.

13. The system of claim 10 wherein the access activity information includes a device data segment and at least one of associated read accesses, write accesses, sequential reads and sequential writes.

14. The system of claim 10 wherein the mass storage devices each include a controller separate from the subsystem controller.

15. The system of claim 10 wherein the subsystem controller is configured to request the access activity information.

16. The system of claim 10 wherein the mass storage devices are configured to move the data among themselves and notifying the subsystem controller that the data has been moved.

17. The system of claim 10 wherein the subsystem controller is capable of configuring the mass storage devices to provide the information.

18. The method of claim 10 wherein the mass storage devices are configured to collect the information for a use separate from moving the data between the tiers.

19. The system of claim 10 wherein the tiers are part of a distributed file system.

20. A subsystem controller comprising storage interfaces electrically coupleable to tiers of mass storage devices and operationally configured to determine movement of data between the tiers responsive to access activity information received from at least some of the mass storage devices.

21. The subsystem controller of claim 20 where the subsystem controller is configured to use at least one policy to determine data movement in conjunction with the access activity information.

22. The subsystem controller of claim 20 wherein the access activity information is received after a request from the subsystem controller.

23. The subsystem controller of claim 22 wherein the request can be periodic or event driven.

24. The subsystem controller of claim 20 further configured to provide configuration information to the mass storage devices for the access activity information.

25. A mass storage device comprising:
mass storage memory; and
a controller coupled to control access to the mass storage memory and including a host interface; the controller configured to collect access activity information for the mass storage memory and output the access activity information from the storage interface response to a request.

26. The mass storage device of claim 25 wherein the controller is configured by a subsystem controller.

27. The mass storage device of claim 25 further comprising a subsystem controller coupled to the controller.

28. The mass storage device of claim 25 wherein the subsystem controller includes a tier interface.

29. The mass storage device of claim 25 wherein the access activity information is output external to the mass storage device.

30. The mass storage device of claim 25 further configured to move with another mass storage device.
